(19) United States
(12) Patent Application Publication
(10) Pub. No.: US 2025/0377907 A1
(43) Pub. Date: Dec. 11, 2025

(54) COMPUTING DEVICE AND METHOD FOR DISPLAYING WIDGET CONTENT INCLUDING IMAGE OF USER GENERATED CONTENT

(71) Applicant: Lemon Inc., Grand Cayman (KY)

(72) Inventors: Ryan NORTHWAY, Culver City, CA (US); Christopher JUNEJA, Culver City, CA (US)

(21) Appl. No.: 18/740,382

(22) Filed: Jun. 11, 2024

(51) Int. Cl. G06F 9/451; G06F 3/0481; G06T 11/60

(52) U.S. Cl. CPC G06F 9/451; G06F 3/0481; G06T 11/60; G06T 2200/24

(57) ABSTRACT

A computing device is provided, including processing circuitry configured to cause a widget to be displayed on a home screen GUI of an operating system of the computing device. The processing circuitry is further configured to obtain location information of a current location of the computing device, and send a request to download widget content from a widget content API of a widget application server of a social media platform, where the request includes the location information. The processing circuitry is further configured to receive the widget content from the widget application server, the widget content including an image of user generated content available on the social media platform that is linked to that user generated content that can be posted on the social medial platform. The processing circuitry is further configured to display the widget content in the widget on the home screen GUI.

### BACKGROUND

Social media platforms empower users to create and share video content. With millions of new videos uploaded daily, the sheer volume of creative content poses a challenge for users seeking personalized recommendations. Developing computer systems that can identify content that resonates with individual preferences of users is becoming increasingly difficult. This challenge is particularly difficult for recently uploaded content that may be trending quickly.

### SUMMARY

A computing device is provided herein. In one example, the computing device includes processing circuitry and memory storing instructions that, during execution, cause the processing circuitry to cause a widget to be displayed on a home screen graphical user interface (GUI) of an operating system of the computing device. The processing circuitry is further configured to obtain location information of a current location of the computing device. The processing circuitry is further configured to send a request to download widget content from a widget content application programming interface (API) of a widget application server of a social media platform. The request includes the location information. The processing circuitry is further configured to receive the widget content from the widget application server, the widget content having been selected based on the location information at the widget application server. The widget content includes an image of user generated content available on the social media platform that is linked to that user generated content that can be posted on the social medial platform. The processing circuitry is further configured to display the widget content in the widget on the home screen GUI.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a client computing device and widget application server of a social media platform.

FIG. 2 shows an example home screen graphical user interface (GUI) of the computing device of FIG. 1, displaying a widget along with application icons.

FIG. 3 shows an example home screen GUI of the computing device of FIG. 1, displaying widget content including an image of user generated content.

FIG. 4 shows an example home screen GUI of the computing device of FIG. 1, displaying the widget content including text information with the image of the user generated content.

FIG. 5 shows an example home screen GUI of the computing device of FIG. 1, displaying the widget content including music information.

FIG. 6 shows a flowchart of a computerized method for displaying the widget content including an image of user generated content.

FIG. 7 shows a schematic view of an example computing environment in which the computing device and widget application server of FIG. 1 may be enacted.

### DETAILED DESCRIPTION

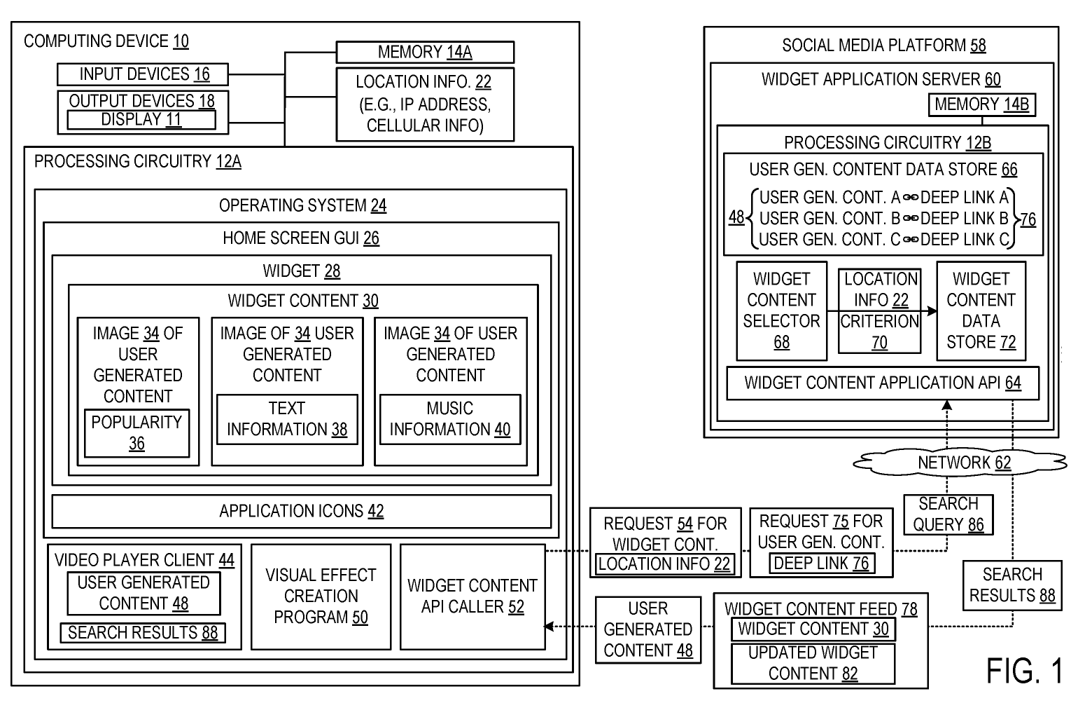

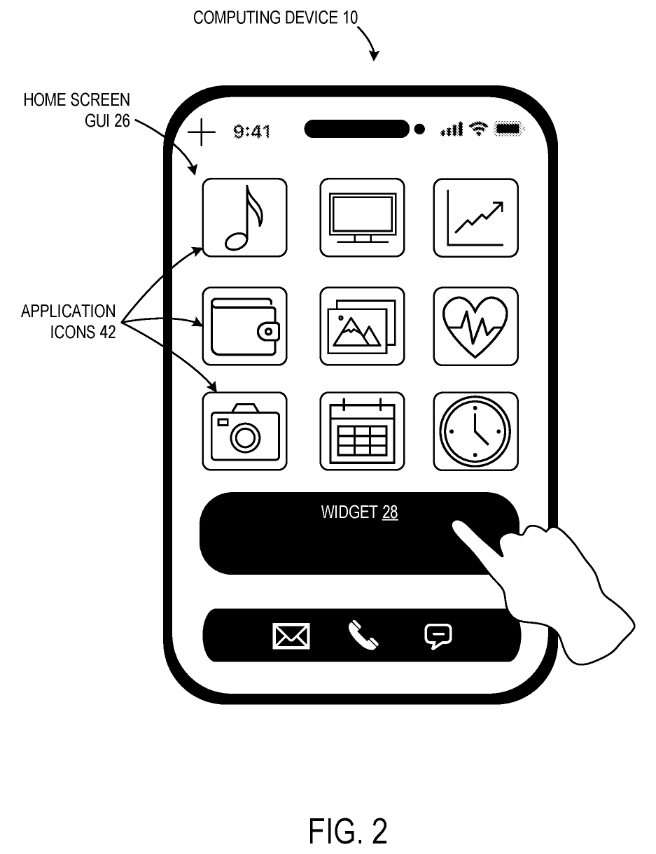

To address the issues described above, FIG. 1 illustrates a computing device 10 for displaying widget content 30 including an image 34 of user generated content. The computing device 10 serves as a client device, which may be a device such as a smartphone, tablet, smartwatch, or personal computer. The computing device 10 comprises processing circuitry 12A, memory 14A, one or more input devices 16 for receiving user input, output devices 18 such as a display 11, and location information 22. The memory 14A stores instructions that, when executed by the processing circuitry 12A, cause the processing circuitry 12A to cause a widget 28 to be displayed on a home screen graphical user interface (GUI) 26 of an operating system 24 of the computing device 10. Briefly turning to FIG. 2, this figure shows an example home screen GUI 26 of the computing device 10 of FIG. 1, displaying the widget 28 along with application icons 42. The widget 28 on the home screen GUI 26 provides timely information from a user’s favorite applications at a glance, such as today’s headlines, weather, stocks, calendars and etc., without having to launch the application. For example, as shown in FIG. 2, the widget 28 can be created by touching and holding an empty area on the home screen GUI 26 and tapping the “+” button on the top-left corner of the screen. Additionally, users (or developers) have the flexibility to choose from various sizes for the widget 28. The application icons 42 may include icons for telephone, email, messaging, web browser, photo, calendar, and clock applications, as some examples.

Turning back to FIG. 1, the processing circuitry 12A is configured to obtain the location information 22 of a current location of the computing device 10. The location information 22 includes an internet protocol (IP) address and/or cellular information that is resolved to determine the current location of the computing device 10. The IP address and/or cellular information can be resolved to a geographic location using a database lookup, for example. The IP address of the computing device 10 itself, or of a Wi-Fi or other access point to which the computing device is connected, is resolvable to a geographic location using a suitable database that stores correspondence information between IP addresses and geographic locations. Alternatively or in addition, cellular information such as a cellular tower ID or Global System for Mobile Communications (GSM) location area code of the computing device or a cellular tower to which the computing device is connected, can also be used to determine the geographic region in which the computing device is located. By querying a database storing the correspondence between such cellular information and different geographic regions, the approximate location of a cellular enabled computing device 10 can be determined. It will be appreciated that the location information 22 also may include the current information designated by a user, which may be entered in the user’s profile of a user account. The processing circuitry 12A is further configured to send a request 54 to download the widget content 30 from a widget content application programming interface (API) 64 of a widget application server 60 of a social media platform 58 via a computing network 62. The request 54 may include the location information 22. The social media platform 58 may be a user video-sharing platform that can be accessed by the video player client 44 on the computing device 10. The video player client 44 may be a user video-sharing application configured to create and play the user generated contents 48 (videos) in a video feed. The user generated contents 48 (videos) in the video feed may be short-form videos that have durations ranging from 15 seconds to 3 minutes. Videos of other durations may also be used.

The widget application server 60 of the social media platform 58 comprises processing circuitry 12B and memory 14B storing instructions that, during execution, cause the processing circuitry 12B to instantiate the widget content application programming interface (API) 64. The widget content API 64 enables users to build interactive and customizable widgets 28. The processing circuitry 12B of the widget application server 60 receives the request 54 for widget content via the widget content API 64 from the client computing device 10. The processing circuitry 12B of the widget application server 60 is further configured to select, via a widget content selector 68, the widget content 30 from a widget content data store 72 based on the location information 22 and a predetermined criterion 70.

Initially, the widget content 30 is selected based on the location information 22, where the selected widget content 30 is related to the current location of the computing device 10. Furthermore, the widget content 30 filtered by the location information 22 may be prioritized by the widget application server 60 based on the criterion 70 selected from the group consisting of popularity, recency, and usage frequency. One criterion 70 may be used for prioritization, or a plurality of these criteria 70 may be used in combination. For instance, if the user generated content 48 of the widget content 30 has been widely viewed and positively received by users, the user generated content 48 of the widget content 30 are prioritized based on popularity. If the user generated content 48 of the widget content 30 has been recently posted on the social media platform 58 and positively received by users, the user generated content 48 of the widget content 30 are prioritized based on recency. If the user generated content 48 of the widget content 30 have been frequently used by users during a certain recent period (e.g., during the last 30 days), the user generated content 48 of the widget content 30 are prioritized based on frequency. It will be appreciated that other criterion 70 can be utilized for widget content selection. For example, the widget content 30 can be prioritized based on a specific content creator.

Moreover, the processing circuitry 12B of the widget application server 60 is further configured to select, via a widget content selector 68, the widget content 30 including the music information 40 from a widget content data store 72 based on the location information 22 and/or a predetermined criterion 70. The widget content 30 including the music information 40 may be selected by the widget application server 60 based on the criterion 70 selected from the group consisting of popularity, recency, and usage frequency. One of these criterion 70 may be used for selection of widget content 30, or a plurality of these criteria 70 may be used in combination. It will be appreciated that the widget content 30 including the music information 40 may be selected based on the criterion 70 alone without the location information 22.

Upon selecting the widget content 30, the processing circuitry 12B of the widget application server 60 is further configured to transmit, via the widget content API 64, the selected widget content 30 in a widget content feed 78 to the client computing device 10 to be displayed on the home screen GUI 26 of the operating system 24 of the client computing device 10. The processing circuitry 12B of the widget application server 60 is further configured to transmit an updated widget content 82 in the widget content feed 78 to the computing device 10 periodically such that the widget contents 30 to be displayed on the home screen GUI 26 of the computing device 10 are updated.

Continuing with FIG. 1, the processing circuitry 12A of the client computing device 10 is configured to receive, via the widget content API caller 52, the widget content 30 from the widget application server 60 and display the widget content 30 in the widget on the home screen GUI 26, the widget content 30 having been selected based on the location information 22 and/or the predetermined criterion 70 at the widget application server 60. The widget content 30 selected by the widget application server 60 may include an image 34 of user generated content available on the social media platform 58 that is linked to that user generated content 48. The user generated content 48 can be posted on the social medial platform 58 and downloaded via a video player client 44 of the computing device 10. The image 34 of the user generated content may be one of the images that is captured from the user generated content 48. The image 34 of the user generated content may be a frame in a video that plays in the widget 28 on the home screen GUI 26, where the image 34 of the user generated content may be a static still image, a dynamic moving video, or other types of media. The widget content 30 may include information pertinent to the current location selected from the group consisting of restaurants, attractions, parks, shopping, and music. For instance, if the current location of the computing device 10 is New York, the widget content 30 may include information and/or images relating to pizza restaurants in New York, the Statue of Liberty, the Brooklyn Bridge, etc. The widget content 30 may also include identification information of a creator of the user generated content 48 and/or popularity information 36 of the user generated content 48 over or along with the image 34 of the user generated content. Furthermore, the widget content 30 may include text information 38 that describes the user generated content 48 along with the image 34 of the user generated content.

Moreover, the widget content 30 selected by the widget application server 60 may include an image 34 of the user generated content that includes music information 40 available on the social media platform 58 that is linked to that user generated content 48 that can be posted on the social medial platform 58. Thus, the music information 40 may include an image 34 of the user generated content that may be generated based on a certain music. The image 34 may be an image of a singer of the music, an album cover, etc. Accordingly, the music information 40 may also include text and/or an image pertinent to a music track.

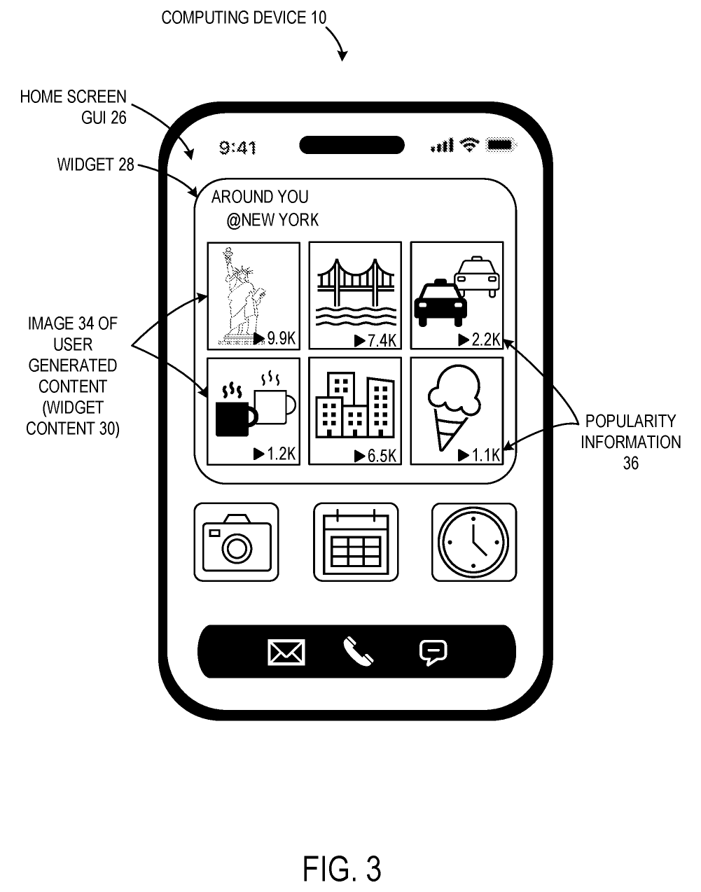

Briefly turning to FIG. 3, this figure shows an example home screen GUI 26 of the computing device 10 of FIG. 1, displaying the widget content 30 including the image 34 of the user generated content. As shown in the depicted example, six widget contents 30 with the images 34 of six different user generated contents are displayed in the widget 28. These contents represent trending spots around New York, which is the current location of the computing device 10. These widget contents 30 are selected based on the current location of the user and further prioritized by popularity. As shown in the depicted example, the images 34 of six different user generated contents include the images of the Statute of Liberty and Brooklyn Bridge, which function as thumbnails. Additionally, the popularity information 36 including “.>2.2K” and “>1.1K” are displayed over the images 34 of the user generated contents of the widget contents 30. It will be appreciated that other information related to the widget content 30, such as creator details and the title of the user-generated content 48, can also be displayed over the image 34 of the user generated content.

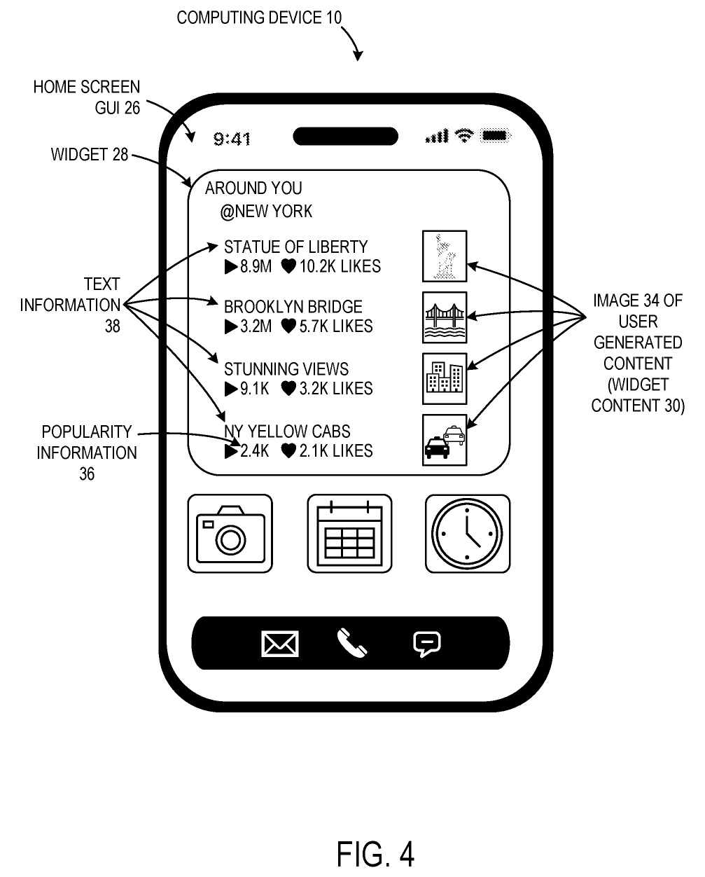

Briefly turning to FIG. 4, this figure shows an example home screen GUI 26 of the computing device 10 of FIG. 1, displaying the widget content 30 including text information 38 with the image 34 of the user generated content. As shown in the depicted example, four widget contents 30 with the text information 38 and the images 34 of four different user generated contents are displayed in the widget 28. These contents represent trending spots around New York, which is the current location of the computing device 10. The text information 38 provides descriptions for the corresponding user generated content 48. Additionally, the popularity information 36 including “>2.4K” and “2.1K LIKES” are displayed over the images 34 of the user generated contents of the widget contents 30.

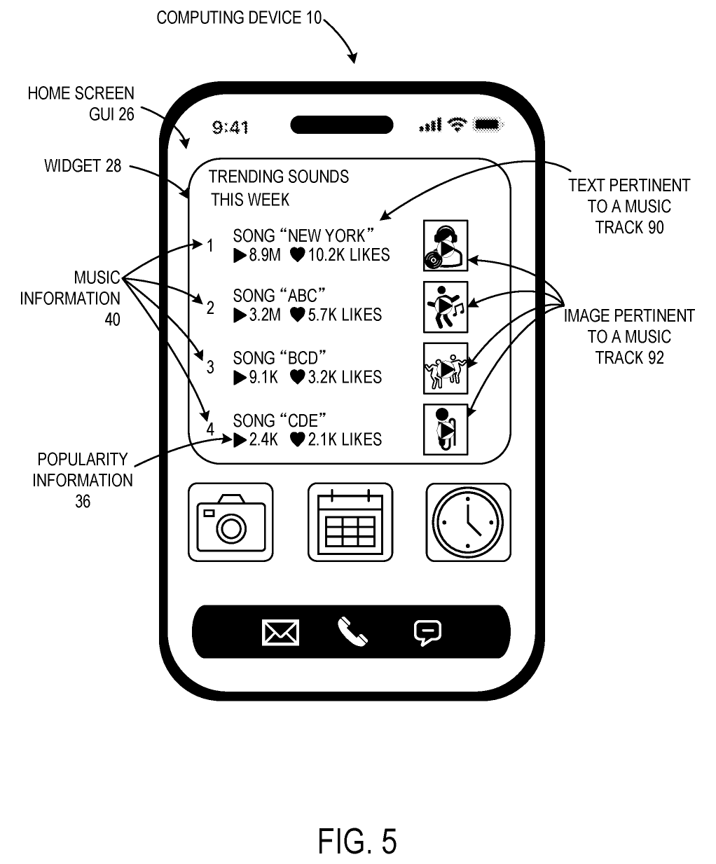

Briefly turning to FIG. 5, this figure shows an example home screen GUI 26 of the computing device 10 of FIG. 1, displaying the widget content 30 including music information 40. As shown in the depicted example, four widget contents 30 with the music information 40 and the images 34 of four different user generated contents are displayed in the widget 28. These contents represent trending sounds or music this week. The music information 40 may include text pertinent to a music track 90 and one or more images pertinent the music track 92. Additionally, popularity information 36 including “>2.4K” and “2.1K LIKES” may be displayed along with the music information 40.

Turning back to FIG. 1, the widget content 30 is linked to the user generated content 48 of the social media platform 58 via a deep link 76. In response to the widget content 30 being tapped by a user, the processing circuitry 12A of the computing device 10 is further configured to send a request 75 for the user generated content including the deep link 76 and transmit to the widget application server 60. The widget application server 60, upon receiving the request 75 for the user generated content, is configured to locate the user generated content 48 stored in a user generated content data store 66 using the deep link 76, and serve the user generated content 48 related to the widget content 30 to the computing device 10. In the user generated content data store 66, each of the user generated contents 48 (A, B, C) is linked to its corresponding deep link 76 (A, B, C) for retrieval.

The processing circuitry 12A of the computing device 10 is further configured to receive the user generated content 48 from the widget application server 60, and display the user generated content 48 using the video player client 44. As a result, users are able to view the user generate content 48 using the video player client 44 by tapping the widget content 30 in the widget 28. Moreover, when the widget content 30 is tapped by a user, the processing circuitry 12A of the computing device 10 is further configured to send a search query 86 including a location parameter indicating the current location to the widget application server 60, and in response receive search results 88 from the widget application server 60 and display the search results 88 in the video player client 44.

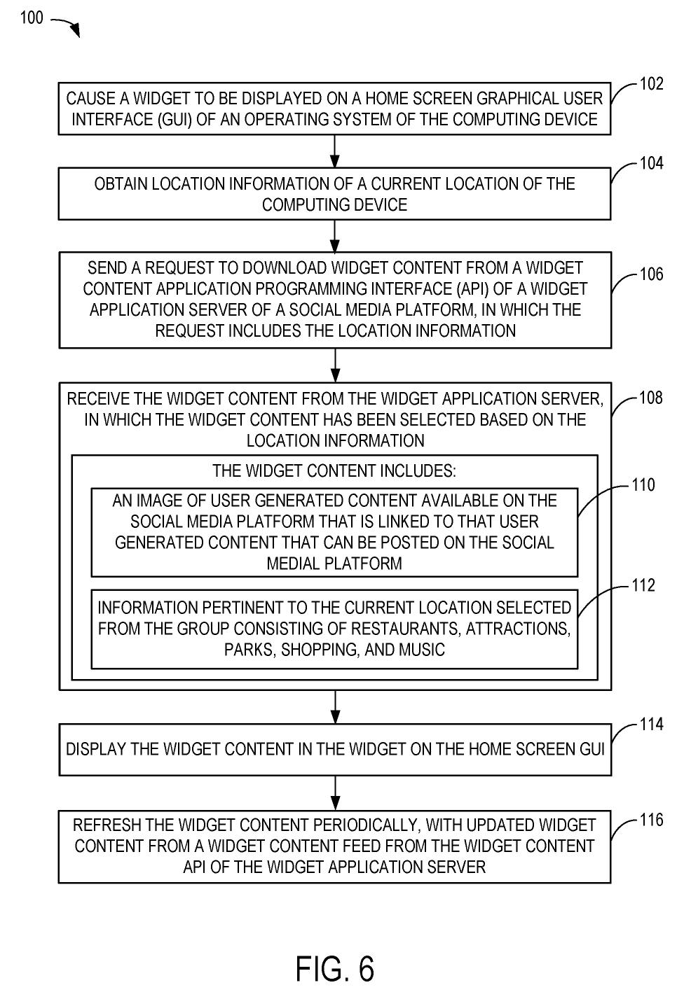

FIG. 6 shows a flowchart of a computerized method 100 for displaying the widget content including the image of the user generated content according to the present disclosure. The method 100 may be implemented by the computing system 10 illustrated in FIG. 1. At 102, the method 100 may include causing a widget to be displayed on a home screen graphical user interface (GUI) of an operating system of the computing device. At 104, the method 100 may include obtaining location information of a current location of the computing device. At 106, the method 100 may include sending a request to download widget content from a widget content application programming interface (API) of a widget application server of a social media platform, in which the request includes the location information. At 108, the method 100 may further include receiving the widget content from the widget application server, the widget content having been selected based on the location information, at the widget application server. The widget content may include an image of user generated content available on the social media platform that is linked to that user generated content that can be posted on the social medial platform (see 110). The widget content includes information pertinent to the current location selected from the group consisting of restaurants, attractions, parks, shopping, and music (see 112). At 114, the method 100 may further include displaying the widget content in the widget on the home screen GUI. At 116, the method 100 may further include refreshing the widget content periodically, with updated widget content from a widget content feed from the widget content API of the widget application server.

The above computing device and method can effectively share trending user generated contents related to the user’s current location or music on social media platforms using widgets. By doing so, users become aware of trending and popular user generated content that provides information around the user’s location or related to the user’s music. These enhancements significantly boost user engagement and overall satisfaction. Moreover, this innovative approach allows content creators to effectively appeal to an appropriate audience effectively. Additionally, the widget-based delivery ensures that users stay informed about the latest user generated contents without having to actively search for them or launch a client program.

In some embodiments, the methods and processes described herein may be tied to a computing system of one or more computing devices. In particular, such methods and processes may be implemented as a computer-application program or service, an application-programming interface (API), a library, and/or other computer-program product.

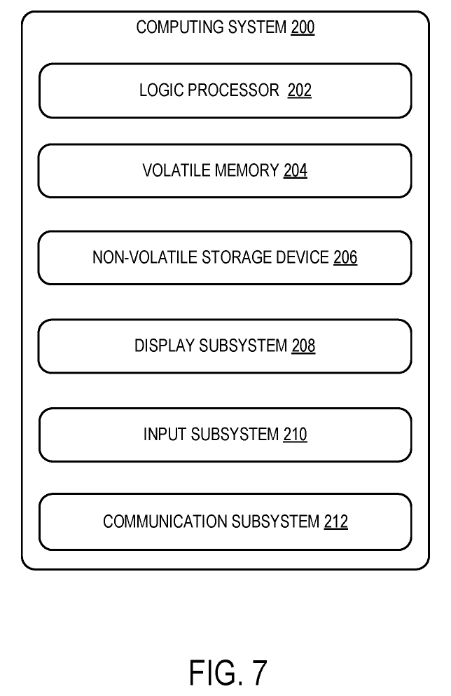

FIG. 7 schematically shows a non-limiting embodiment of a computing device 10 or widget application server 60 that can enact one or more of the methods and processes described above. Computing system 200 is shown in simplified form. Computing system 200 may embody the computer device 10 described above and illustrated in FIG. 1. Computing system 200 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 200 includes a logic processor 202 volatile memory 204, and a non-volatile storage device 206. Computing system 200 may optionally include a display subsystem 208, input subsystem 210, communication subsystem 212, and/or other components not shown in FIG. 7.

Logic processor 202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 206 includes one or more physical devices configured to hold instructions executable by the logic processors to implement the methods and processes described herein. When such methods and processes are implemented, the state of non-volatile storage device 206 may be transformed—e.g., to hold different data.

Non-volatile storage device 206 may include physical devices that are removable and/or built-in. Non-volatile storage device 206 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by logic processor 202 to temporarily store information during processing of software instructions. It will be appreciated that volatile memory 204 typically does not continue to store instructions when power is cut to the volatile memory 204.

Aspects of logic processor 202, volatile memory 204, and non-volatile storage device 206 may be integrated together into one or more hardware-logic components. Such hardware-logic components may include field-programmable gate arrays (FPGAs), program- and application-specific integrated circuits (PASIC / ASICs), program- and application-specific standard products (PSSP / ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 200 to send and/or receive messages to and/or from other devices via a network such as the Internet.

The following paragraphs provide additional description of the subject matter of the present disclosure. One aspect provides a computing device comprising processing circuitry and memory storing instructions that, during execution, cause the processing circuitry to cause a widget to be displayed on a home screen graphical user interface (GUI) of an operating system of the computing device. The processing circuitry is further configured to obtain location information of a current location of the computing device. The processing circuitry is further configured to send a request to download widget content from a widget content application programming interface (API) of a widget application server of a social media platform, the request including the location information. The processing circuitry is further configured to receive the widget content from the widget application server, the widget content having been selected based on the location information, and the widget content including an image of user generated content available on the social media platform that is linked to the user generated content posted on the social media platform. The processing circuitry is further configured to display the widget content in the widget on the home screen GUI.

In this aspect, the widget content may be linked to user generated content of the social media platform via a deep link, and the processing circuitry may be further configured to, in response to the widget content being tapped by a user, send a request for the user generated content including the deep link and transmit to the widget application server, receive the user generated content from the widget application server, the user generated content being located using the deep link and served by the widget application server, and display the user generated content.

In this aspect, the widget content may be linked to user generated content of the social media platform, and when the widget content is tapped by a user, the processing circuitry may be configured to send a search query including a location parameter indicating the current location to the widget application server, and in response receive search results from the widget application server and display the search results.

In this aspect, the location information may include IP address and/or cellular information indicating the current location.

In this aspect, the location information may include the current location designated by a user.

In this aspect, the widget content may include text description with the image of the user generated content.

In this aspect, the widget content may include information pertinent to the current location selected from the group consisting of restaurants, attractions, parks, shopping, and music.

In this aspect, the widget content may be prioritized by the widget application server based on criterion selected from the group consisting of popularity, recency, and usage frequency.

Another aspect provides a computerized method comprising causing a widget to be displayed on a home screen graphical user interface (GUI) of an operating system of the computing device, obtaining location information of a current location of the computing device, sending a request to download widget content from a widget content application programming interface (API) of a widget application server of a social media platform, the request including the location information, receiving the widget content from the widget application server, the widget content having been selected based on the location information, and the widget content including an image of user generated content available on the social media platform that is linked to that user generated content that can be posted on the social medial platform, and displaying the widget content in the widget on the home screen GUI.

In this aspect, the widget content may be linked to user generated content of the social media platform via a deep link, and the computerized method may further comprise, when the widget content is tapped by a user, sending a search query including a location parameter indicating the current location to the widget application server, and in response receiving search results from the widget application server and displaying the search results.

In this aspect, the location information may include IP address and/or cellular information indicating the current location.

In this aspect, the location information may include the current location designated by a user

In this aspect, the widget content may include information pertinent to the current location selected from the group consisting of restaurants, attractions, parks, shopping, and music.

In this aspect, the widget content may be prioritized by the widget application server based on criterion selected from the group consisting of popularity, recency, and usage frequency.

In this aspect, the computerized method may further comprise refreshing the widget content periodically, with updated widget content from a widget content feed from the widget content API of the widget application server.

Another aspect provides a computing device comprising processing circuitry and memory storing instructions that, during execution, cause the processing circuitry to cause a widget to be displayed on a home screen graphical user interface (GUI) of an operating system of the computing device. The processing circuitry is further configured to send a request to download widget content from a widget content application programming interface (API) of a widget application server of a social media platform. The processing circuitry is further configured to receive the widget content from the widget application server, the widget content having been selected based on the location information, and the widget content including an image of user generated content that includes music information available on the social media platform that is linked to that user generated content that can be posted on the social medial platform. The processing circuitry is further configured to display the widget content in the widget on the home screen GUI.

In this aspect, the widget content may be linked to user generated content of the social media platform via a deep link, and the processing circuitry may be further configured to, in response to the widget content being tapped by a user, send a request for user generated content including the deep link and transmit to the widget application server, receive the user generated content from the widget application server, the user generated content being located using the deep link and served by the widget application server, and display the user generated content.

In this aspect, the widget content may have been selected based on user location information transmitted to the widget application server from the processing circuitry of the computing device.

In this aspect, the music information may include text and/or image pertinent to a music track.

In this aspect, the widget content may be selected by the widget application server based on criterion selected from the group consisting of popularity, recency, and usage frequency.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
processing circuitry and memory storing instructions that, during execution, cause the processing circuitry to:
cause a widget to be displayed on a home screen graphical user interface (GUI) of an operating system of the computing device;
obtain location information of a current location of the computing device;
send a request to download widget content from a widget content application programming interface (API) of a widget application server of a social media platform, the request including the location information;
receive the widget content from the widget application server, the widget content having been selected based on the location information, and the widget content including an image of user generated content available on the social media platform that is linked to the user generated content posted on the social media platform; and
display the widget content in the widget on the home screen GUI.

2. The computing device of claim 1, wherein
the widget content is linked to user generated content of the social media platform via a deep link, and
the processing circuitry is further configured to:
in response to the widget content being tapped by a user, send a request for the user generated content including the deep link and transmit to the widget application server,
receive the user generated content from the widget application server, the user generated content being located using the deep link and served by the widget application server, and
display the user generated content.

3. The computing device of claim 1, wherein
the widget content is linked to user generated content of the social media platform, and
when the widget content is tapped by a user, the processing circuitry is configured to send a search query including a location parameter indicating the current location to the widget application server, and in response receive search results from the widget application server and display the search results.

4. The computing device of claim 1, wherein
the location information includes an IP address and/or cellular information that is resolved to determine the current location.

5. The computing device of claim 1, wherein
the location information includes the current location designated by a user.

6. The computing device of claim 1, wherein
the widget content includes text description with the image of the user generated content.

7. The computing device of claim 1, wherein
the widget content includes information pertinent to the current location selected from the group consisting of restaurants, attractions, parks, shopping, and music.

8. The computing device of claim 1, wherein
the widget content is prioritized by the widget application server based on criterion selected from the group consisting of popularity, recency, and usage frequency.

9. A computerized method, comprising:
causing a widget to be displayed on a home screen graphical user interface (GUI) of an operating system of the computing device;
obtaining location information of a current location of the computing device;
sending a request to download widget content from a widget content application programming interface (API) of a widget application server of a social media platform, the request including the location information;
receiving the widget content from the widget application server, the widget content having been selected based on the location information, and the widget content including an image of user generated content available on the social media platform that is linked to that user generated content that can be posted on the social medial platform; and
displaying the widget content in the widget on the home screen GUI.

10. The computerized method of claim 9, wherein
the widget content is linked to user generated content of the social media platform via a deep link, and
the computerized method further comprises:
when the widget content is tapped by a user, sending a search query including a location parameter indicating the current location to the widget application server, and
in response receiving search results from the widget application server and displaying the search results.

11. The computerized method of claim 9, wherein
the location information includes an IP address and/or cellular information that is resolved to determine the current location.

12. The computerized method of claim 9, wherein
the location information includes the current location designated by a user.

13. The computerized method of claim 9, wherein
the widget content includes information pertinent to the current location selected from the group consisting of restaurants, attractions, parks, shopping, and music.

14. The computerized method of claim 9, wherein
the widget content is prioritized by the widget application server based on criterion selected from the group consisting of popularity, recency, and usage frequency.

15. The computerized method of claim 9, further comprising:
refreshing the widget content periodically, with updated widget content from a widget content feed from the widget content API of the widget application server.

16. A computing device, comprising:
processing circuitry and memory storing instructions that, during execution, cause the processing circuitry to:
cause a widget to be displayed on a home screen graphical user interface (GUI) of an operating system of the computing device;
send a request to download widget content from a widget content application programming interface (API) of a widget application server of a social media platform;
receive the widget content from the widget application server, the widget content having been selected based on the location information, and the widget content including an image of user generated content that includes music information available on the social media platform that is linked to that user generated content that can be posted on the social medial platform; and
display the widget content in the widget on the home screen GUI.

17. The computing device of claim 16, wherein
the widget content is linked to user generated content of the social media platform via a deep link, and
the processing circuitry is further configured to:
in response to the widget content being tapped by a user, send a request for user generated content including the deep link and transmit to the widget application server,
receive the user generated content from the widget application server, the user generated content being located using the deep link and served by the widget application server, and
display the user generated content.

18. The computing device of claim 16, wherein
the widget content has been selected based on user location information transmitted to the widget application server from the processing circuitry of the computing device.

19. The computing device of claim 16, wherein
the music information includes text and/or image pertinent to a music track.

20. The computing device of claim 16, wherein
the widget content is selected by the widget application server based on criterion selected from the group consisting of popularity, recency, and usage frequency.
